(19) United States
(12) Patent Application Publication
(10) Pub. No.: US 2026/0183855 A1
(43) Pub. Date: Jul. 2, 2026

(54) ULTRASONIC MEASUREMENT OF ELECTRODE DEPTH WHILE ELECTRICAL DISCHARGE MACHINING

(71) Applicant: GE INFRASTRUCTURE TECHNOLOGY LLC, Greenville, SC (US)

(72) Inventors: James Scott FLANAGAN, Greenville, SC (US); Thomas James BATZINGER, Schenectady, NY (US); Thomas Earnest MOLDENHAUER, Schenectady, NY (US)

(21) Appl. No.: 19/127,332

(22) PCT Filed: Nov. 10, 2022
(86) PCT No.: PCT/US2022/079605

§ 371 Date: May 5, 2025

(51) Int. Cl. B23H 7/32; B23H 1/02; B23H 7/18

(52) U.S. Cl. CPC B23H 7/32; B23H 1/02; B23H 7/18

(57) ABSTRACT

An electrical discharge machine includes an electrode configured to machine a conductive workpiece by application of repetitive electric charges therefrom, and a controller operatively coupled to the electrode and configured to control application of the repetitive electric charges. The EDM also includes an ultrasonic sensor operatively coupled to the electrode and operatively coupled to the controller. The controller also determines a depth of the electrode in the conductive workpiece based on data from the ultrasonic sensor.

### TECHNICAL FIELD

The disclosure relates generally to machining, and more particularly, to ultrasonic measurement of electrode depth while electrical discharge machining.

### BACKGROUND

Electrical discharge machining (EDM) is a machining process that removes material from a conductive workpiece by a series of repeated electrical discharges between an electrode and the conductive workpiece being machined. One challenge with EDM is detecting when an electrode is about to break through a surface of the conductive workpiece opposing the surface being machined. Current approaches try to infer a depth of the electrode in the part from other process parameters, e.g., duration, but none of these approaches directly measures the depth of the electrode in the conductive workpiece being machined.

### BRIEF DESCRIPTION

All aspects, examples and features mentioned below can be combined in any technically possible way.

An aspect of the disclosure provides an electrical discharge machine (EDM), comprising: an electrode configured to machine a conductive workpiece by application of repetitive electric charges therefrom; an electrode positioner operatively coupled to the electrode to control positioning of the electrode in three-dimensional space; a controller operatively coupled to the electrode and the electrode positioner and configured to control application of the repetitive electric charges; and an ultrasonic sensor operatively coupled to the electrode and operatively coupled to the controller, wherein the controller determines a depth of the electrode in the conductive workpiece based on data from the ultrasonic sensor and the electrode positioner.

Another aspect of the disclosure includes any of the preceding aspects, and the ultrasonic sensor includes an electromagnetic acoustic transducer (EMAT) positioned around the electrode.

Another aspect of the disclosure includes any of the preceding aspects, and the ultrasonic sensor includes a piezoelectric ultrasonic transducer positioned around the electrode.

Another aspect of the disclosure includes any of the preceding aspects, and the controller further determines a distance to breakthrough of the conductive workpiece at a given position during operation based on the depth of the electrode in the conductive workpiece and a known thickness of the conductive workpiece at the given position.

Another aspect of the disclosure includes any of the preceding aspects, and the controller operates the ultrasonic sensor intermittently with application of the repetitive electric charges from the electrode, and determines the depth of the electrode in the conductive workpiece based on the data from the ultrasonic sensor during operation of the EDM.

Another aspect of the disclosure includes any of the preceding aspects, and the controller operates the ultrasonic sensor after completion of application of a series of the repetitive electric charges from the electrode.

An aspect of the disclosure includes a method, comprising: electrical discharge machining a conductive workpiece using an electrode, a three-dimensional position of the electrode known from an electrode positioner; determining a length of the electrode using an ultrasonic sensor operatively coupled to the electrode; and determining a depth of the electrode in the conductive workpiece based on the length of the electrode and the three-dimensional position of the electrode Another aspect of the disclosure includes any of the preceding aspects, and the ultrasonic sensor includes an electromagnetic acoustic transducer operatively coupled to the electrode.

Another aspect of the disclosure includes any of the preceding aspects, and the ultrasonic sensor includes a piezoelectric ultrasonic transducer positioned around the electrode.

Another aspect of the disclosure includes any of the preceding aspects, and further comprising determining a distance to breakthrough of the conductive workpiece at a given position during operation based on the depth of the electrode in the conductive workpiece and a known thickness of the conductive workpiece at the given position.

Another aspect of the disclosure includes any of the preceding aspects, and the controller operates the ultrasonic sensor intermittently with application of the repetitive electric charges from the electrode, and the determining the depth of the electrode in the conductive workpiece based on the data from the ultrasonic sensor occurs during the electrical discharge machining.

Another aspect of the disclosure includes any of the preceding aspects, and the controller operates the ultrasonic sensor after completion of application of a series of the repetitive electric charges from the electrode, and the determining the depth of the electrode in the conductive workpiece based on the data from the ultrasonic sensor occurs after the electrical discharge machining.

Two or more aspects described in this disclosure, including those described in this summary section, may be combined to form implementations not specifically described herein.

The details of one or more implementations are set forth in the accompanying drawings and the description below. Other features, workpieces and advantages will be apparent from the description and drawings, and from the claims.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a schematic, partially cross-sectional view of an electrical discharge machine with an ultrasonic sensor, according to embodiments of the disclosure;

FIG. 2 shows a schematic, partially cross-sectional view of an electrical discharge machine with an ultrasonic sensor, according to embodiments of the disclosure; and

FIG. 3 shows a flow diagram illustrating a method of operation of the electrical discharge machine, according to embodiments of the disclosure.

It is noted that the drawings of the disclosure are not necessarily to scale. The drawings are intended to depict only typical aspects of the disclosure and therefore should not be considered as limiting the scope of the disclosure. In the drawings, like numbering represents like elements between the drawings.

### DETAILED DESCRIPTION

As an initial matter, in order to clearly describe the current disclosure, it will become necessary to select certain terminology when referring to and describing relevant machine components within the illustrative application of an electrical discharge machine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event may or may not occur or that the subsequently described feature may or may not be present and that the description includes instances where the event occurs or the feature is present and instances where the event does not occur or the feature is not present.

Where an element or layer is referred to as being “on,” “engaged to,” “disengaged from,” “connected to” or “coupled to” or “mounted to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there are no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The verb forms of “couple” and “mount” may be used interchangeably herein.

As indicated above, the disclosure provides an electrical discharge machine (EDM). The EDM includes an electrode for machining a conductive workpiece by applying repetitive electric charges therefrom, and a controller operatively coupled to the electrode to control application of the repetitive electric charges. The EDM also includes an ultrasonic sensor operatively coupled to the electrode and operatively coupled to the controller. The controller can determine a depth of the electrode in the conductive workpiece based on data from the ultrasonic sensor. Knowing the thickness of the conductive workpiece at a given position, the controller can also determine a distance to breakthrough of the conductive workpiece based on data from the ultrasonic sensor, making the EDM process more precise and preventing breakthrough when it is undesired and/or damage to other features of the workpiece caused by not knowing the depth of the electrode.

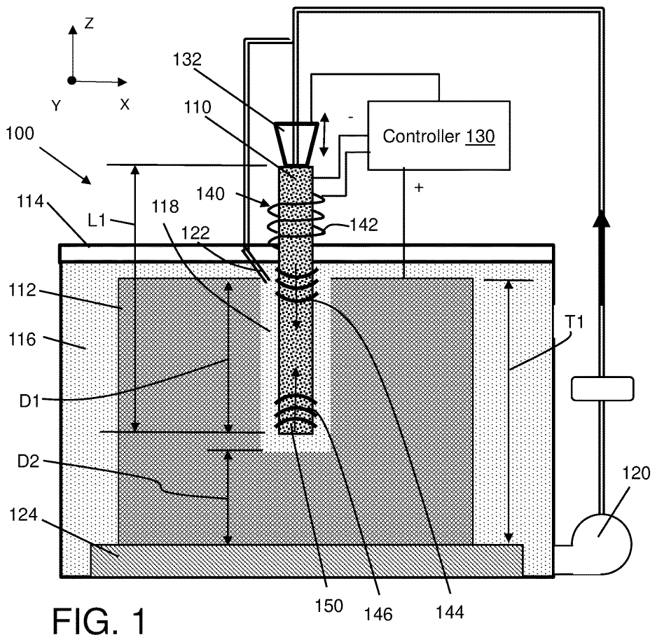

FIG. 1 shows a schematic, partially cross-sectional view an EDM 100 according to embodiments of the disclosure. Electrical discharge machining is a fabrication process in which a desired shape is obtained by using electric charges, e.g., sparks to remove and/or shape a conductive workpiece. Electrical discharge machining may also be known as spark eroding, spark machining, die sinking, wire erosion or wire burning.

EDM 100 includes an electrode 110 configured to machine a conductive workpiece 112 by applying repetitive electric charges therefrom. Conductive workpiece 112 (hereafter “workpiece 112”) can include any conductive metal structure and perhaps some conductive ceramic structures. In one non-limiting example, workpiece 112 may include a turbine nozzle or blade. Electrode 110 may include any appropriate material typically used for an EDM. While shown as rectangular in cross-section, electrode 110 may have any shape and/or size to create the desired machining in workpiece 112. As understood in the field, as EDM 100 operates, electrode 110 is consumed, and changes length over time.

EDM 100 may also include a tank 114 for holding a dielectric 116 in which conductive workpiece 112 is supported. Dielectric 116 may include any now known or later developed liquid dielectric appropriate for electrical discharge machining. Dielectric 116 may be circulated through tank 114 and a machining area 118 adjacent electrode 110, i.e., within workpiece 112, using any now known or later developed pumping system 120 and related piping. For example, dielectric 116 may be delivered to machining area 118 at an outlet 122 such as a nozzle. Optionally, dielectric 116 may be passed through an opening (not shown for clarity) in electrode 110. Workpiece 112 may be supported on any form of support 124 in tank 114.

EDM 100 also includes a controller 130 operatively coupled to electrode 110. Controller 130 may include any computerized industrial control system capable of controlling operation of, among other things, application of the repetitive electric charges to electrode 110 and workpiece 112, pumping system 120 and an ultrasonic sensor 140. Controller 130 also controls and interacts with an EDM positioner 132 to position electrode 110. EDM positioner 132 may include any now known or later developed robotic positioning system operatively coupled to electrode 110 to control positioning (e.g., location and movement) of electrode 110 in three-dimensional (X, Y, Z) space, e.g., relative to workpiece 112. For example, EDM positioner 132 can position and move electrode 110 in any X, Y, Z position relative to workpiece 112. Controller 130, via EDM positioner 132, also knows a relative position of electrode 110 relative to workpiece 112 and controls a vector along which electrode 110 moves into workpiece 112, i.e., a tooling vector. For purposes of description, the tooling vector is illustrated as a Z direction (vertical on page), but it will be recognized that the tooling vector can be in any direction depending on the direction in which electrode 110 is advancing into workpiece 112. In any event, controller 130 knows the position of electrode 110 in any X, Y, Z position relative to workpiece 112.

EDM 100 also includes an ultrasonic sensor 140 operatively coupled to electrode 110 and operatively coupled to controller 130. Ultrasonic sensor 140 can take a number of forms. In one embodiment, ultrasonic sensor 140 includes an electromagnetic acoustic transducer (EMAT) 142 positioned at least in part around electrode 110. A position of EMAT 142 and, in particular, a coil thereof is known relative to electrode 110. EMAT 142 may transmit/induce ultrasonic signals 144 into workpiece 112 with two interacting magnetic fields. A radio frequency (RF) field is generated by the coil of ultrasonic sensor 140 and interacts with a lower or static frequency field generated by magnets to generate a Lorentz force. The Lorentz force communicates to workpiece 112 producing an elastic wave. In a reversing process, the elastic waves interact in the presence of a magnetic field to create a return signal 146 that creates currents in the coil of EMAT 142. EMAT 142 may operate in a standard manner but can have a propagation mode and/or frequency of its transmitted signal 144 customized for the workpiece 112 material and dielectric 116 material to minimize leakage into dielectric 116 and provide a desired reflection from electrode 110 to allow measurement of the time of flight.

Controller 130 determines a length L1 of electrode 110 using ultrasonic sensor 140 operatively coupled to electrode 110, e.g., based on data from EMAT 142. In this manner, a location of a tip of electrode 110 can be identified. Controller 130, with data from EDM positioner 132 and ultrasonic sensor 140, can also determine a depth D1 of electrode 110 in workpiece 112. Controller 130 determines a depth D1 of electrode 110 in workpiece 112 based on the length L1 of electrode 110 (from ultrasonic sensor 140) and the three-dimensional position of electrode 110, i.e., 3D position relative to workpiece 112 known from EDM positioner 132. More particularly, transmitted signal 144 and return signal 146 can be evaluated by controller 130 using any appropriate time of flight calculation in conjunction with the EDM positioner to identify a length L1 of electrode 110. Further, controller 130 can determine a depth D1 of electrode 110 in workpiece 112 knowing the length L1 and the relative position of electrode 110 and workpiece 112, i.e., by simple differencing of the length of electrode 110 and how far it has moved relative to the known surface of workpiece 112.

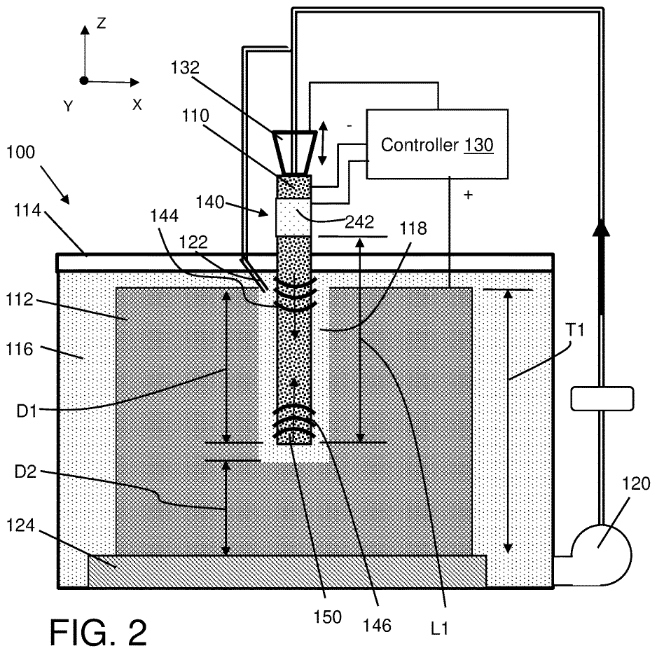

In another embodiment, shown in the schematic, partially cross-sectional view of FIG. 2, ultrasonic sensor 140 may include a piezoelectric ultrasonic transducer (PUT) 242 positioned on electrode 110. Length L2 of electrode 110 below PUT 242 is referenced by controller 130. PUT 242 works in a similar manner as EMAT 142, described above.

In some cases, machining operation of EDM 100 may interfere with operation of ultrasonic sensor 140. To address this situation, in certain embodiments, controller 130 may operate ultrasonic sensor 140 intermittently with application of the repetitive electric charges from electrode 110. That is, ultrasonic sensor 140 signals 144, 146 are transmitted/received between electric charges being emitted from electrode 110. More particularly, ultrasonic sensor 140 signals 144, 146 are transmitted/received between the normal durations between electric charges as EDM 100 operates. In this case, controller 130 may determine depth D1 of electrode 110 in workpiece 112 based on the data from ultrasonic sensor 140 during operation of EDM 100, i.e., without stopping machining. In another embodiment, controller 130 may operate ultrasonic sensor 140 after completion of application of a series of the repetitive electric charges from electrode 110. That is, ultrasonic sensor 140 signals 144, 146 are transmitted/received during a period when electric charges are not being emitted from electrode 110, i.e., not between the normal durations between electric charges as EDM 100 operates.

In certain embodiments, controller 130 may further determine a distance D2 to breakthrough of workpiece 112 at a given position during operation based on depth D1 of electrode 110 in workpiece 112 and a known thickness T1 of workpiece 112 at the given position. More particularly, distance to breakthrough D2 equals known thickness T1 minus depth D1 of electrode 110, i.e., D2=T1-D1.

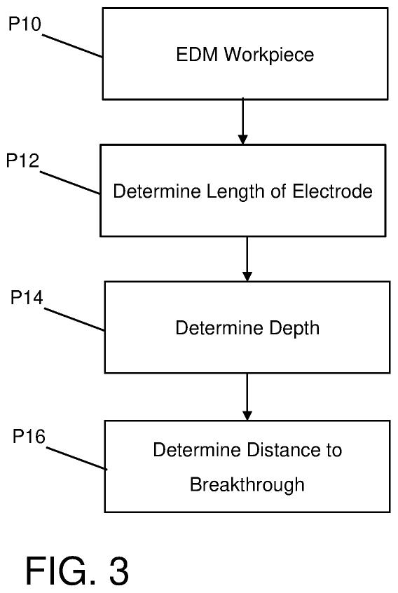

FIG. 3 shows a flow diagram illustrating a method of operation of EDM 100. Embodiments of the method may include, in process P10, electrical discharge machining workpiece 112 using electrode 110. In process P12, controller 130 may determine a length of electrode 110, e.g., based on data from ultrasonic sensor 140. In process P14, controller 130 may determine a depth of electrode 110 in workpiece 112 based on the length of electrode 110 (from ultrasonic sensor 140) and the three-dimensional position of electrode 110. The three-dimensional position of electrode 110 is known from electrode positioner 132. A depth of electrode 110 in workpiece 112 can be determined knowing the length and the relative position of electrode 110 and workpiece 112, i.e., by simple differencing of the length and the known surface position of the workpiece 112.

As noted, ultrasonic sensor 140 may include EMAT 142 (FIG. 1) or PUT 242 (FIG. 2) operatively coupled to electrode 110. In optional process P16, controller 130 may determine a distance D2 to breakthrough of workpiece 112 at a given position during operation based on depth D1 of electrode 110 in workpiece 112 and a known thickness T1 of workpiece 112 at the given position. Controller 130 may operate ultrasonic sensor 140 intermittently with application of the repetitive electric charges from electrode 110 and may determine depth D1 of electrode 110 in workpiece 112 based on the data from ultrasonic sensor 140 during the electrical discharge machining (i.e., process P14 occurs during process P10). In other embodiments, controller 130 operates ultrasonic sensor 140 after completion of application of a series of the repetitive electric charges from electrode 110 and determines depth D1 of electrode 110 in workpiece 112 based on the data from ultrasonic sensor 140 occurs after the electrical discharge machining (i.e., process P14 does not occur during process P10).

Embodiments of the disclosure provide various technical and commercial advantages, examples of which are discussed herein. The use of the ultrasonic sensor with the EDM provides a direct measurement of the electrode depth, perhaps as machining occurs, such that penetration through the conductive workpiece can be controlled as required. This technique also enables the direct measurement of the remaining material thickness prior to electrode break through.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise. “Approximately,” as applied to a particular value of a range, applies to both end values and, unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

What is claimed is:

1. An electrical discharge machine (EDM), comprising:
an electrode configured to machine a conductive workpiece by application of repetitive electric charges therefrom;
an electrode positioner operatively coupled to the electrode to control positioning of the electrode in three-dimensional space;
a controller operatively coupled to the electrode and the electrode positioner and configured to control application of the repetitive electric charges; and
an ultrasonic sensor operatively coupled to the electrode and operatively coupled to the controller,
wherein the controller determines a depth of the electrode in the conductive workpiece based on data from the ultrasonic sensor and the electrode positioner.

2. The EDM of claim 1, wherein the ultrasonic sensor includes an electromagnetic acoustic transducer (EMAT) positioned around the electrode.

3. The EDM of claim 1, wherein the ultrasonic sensor includes a piezoelectric ultrasonic transducer positioned around the electrode.

4. The EDM of claim 1, wherein the controller further determines a distance to breakthrough of the conductive workpiece at a given position during operation based on the depth of the electrode in the conductive workpiece and a known thickness of the conductive workpiece at the given position.

5. The EDM of claim 1, wherein the controller operates the ultrasonic sensor intermittently with application of the repetitive electric charges from the electrode, and determines the depth of the electrode in the conductive workpiece based on the data from the ultrasonic sensor during operation of the EDM.

6. The EDM of claim 1, wherein the controller operates the ultrasonic sensor after completion of application of a series of the repetitive electric charges from the electrode.

7. A method, comprising:
electrical discharge machining a conductive workpiece using an electrode, a three-dimensional position of the electrode known from an electrode positioner;
determining a length of the electrode using an ultrasonic sensor operatively coupled to the electrode; and
determining a depth of the electrode in the conductive workpiece based on the length of the electrode and the three-dimensional position of the electrode.

8. The method of claim 7, wherein the ultrasonic sensor includes an electromagnetic acoustic transducer operatively coupled to the electrode.

9. The method of claim 7, wherein the ultrasonic sensor includes a piezoelectric ultrasonic transducer positioned around the electrode.

10. The method of claim 7, further comprising determining a distance to breakthrough of the conductive workpiece at a given position during operation based on the depth of the electrode in the conductive workpiece and a known thickness of the conductive workpiece at the given position.

11. The method of claim 7, wherein the controller operates the ultrasonic sensor intermittently with application of the repetitive electric charges from the electrode, and the determining the depth of the electrode in the conductive workpiece based on the data from the ultrasonic sensor occurs during the electrical discharge machining.

12. The method of claim 7, wherein the controller operates the ultrasonic sensor after completion of application of a series of the repetitive electric charges from the electrode, and the determining the depth of the electrode in the conductive workpiece based on the data from the ultrasonic sensor occurs after the electrical discharge machining.
